(19) United States
(12) Patent Application Publication
(10) Pub. No.: US 2009/0187897 A1
(43) Pub. Date: Jul. 23, 2009

(54) COMPILING METHOD AND COMPILING PROGRAM

(75) Inventor: Shinobu Asao, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/329,014

(22) Filed: Dec. 5, 2008

(30) Foreign Application Priority Data
Jan. 18, 2008 (JP) 2008-009787

(51) Int. Cl. G06F 9/45

(52) U.S. Cl. 717/154

(57) ABSTRACT

The compiling method and compiling program which can delete a redundantly generated function, regardless of whether or not a class object is generated and whether or not calling is performed is a compiling method for converting an input program written in an object-oriented language and having at least one class into an object program, and which includes: a virtual inheritance analyzing step of analyzing whether or not each class in the input program is defined by virtual inheritance; a special function consolidating step of generating a code which consolidates at least one of plural constructors and plural destructors of the class, in the case where, as a result of the analysis in the virtual inheritance analyzing step, the class is not defined by virtual inheritance; and a generating step of generating an object program including the code generated in the special function consolidating step.

### BACKGROUND OF THE INVENTION

(1) Field of the Invention

The present invention relates to compiling methods and compiling programs, and particularly to a compiling method and a compiling program for converting, into an object program, an input program written in an object-oriented language and having at least one class.

(2) Description of the Related Art

In the development of software in recent years, there has been an increase in the scale of programs. As such, object-oriented language, which has high serviceability and reusability, is being focused on. Here, object-oriented language refers to language which describes the behavior of objects, and describes a program using a combination of such objects. Furthermore, an object refers to a collective unit into which data and a procedure (method) for operating the data are encapsulated.

As an object-oriented language, there is “C++” for example. Furthermore, “C++” is a programming language that is an object-oriented expansion of the procedural programming language “C”. In addition, “C++” is attracting attention as a replacement for “C” which has been widely used in programming for many years, and transition of programming from “C” to “C++” is underway in various places.

However, although, on the one hand, “C++” has various improved functions compared to “C”, redundant codes are generated. Consequently, various techniques are proposed for reducing such redundant codes (for example, Patent Reference 1 or Patent Reference 2).

Patent Reference 1 discloses a method of deleting functions of a class of which an object will not be generated.

Here, a class defines a template of an object encapsulating data and a method which is the operating procedure for the data, in object-oriented programming. By such definition, it becomes possible to collectively handle objects of the same type.

Patent Reference 2 discloses a method which does not generate a function definition for a method that will not be called.

Here, a function is the set of a series of statements of receiving data referred to as an argument, performing a predetermined manner of processing on the received data, and returning the result. In many programming languages, functions are elements which make up a program.

### Patent Reference 1: Japanese Unexamined Patent Application Publication No. 2005-18425

### Patent Reference 1: Japanese Unexamined Patent Application Publication No. 2006-285584

### SUMMARY OF THE INVENTION

However, the method disclosed in the aforementioned Patent Reference 1 is limited to a class of which an object is not generated, and cannot delete redundant functions in a class of which an object is generated. Furthermore, the method disclosed in the aforementioned Patent Reference 2 is limited to a method that will not be called, and cannot handle cases where calling is performed and redundant function definitions exist.

The present invention is conceived in view of these problems and has as an object to provide a compiling method and a compiling program which can delete a redundantly generated function, regardless of whether or not a class object is generated and whether or not calling is performed.

In order to solve the aforementioned problems, the compiling method according to the present invention is A compiling method for converting, into an object program, an input program written in an object-oriented language and having at least one class, the compiling method including: a virtual inheritance analyzing step of analyzing whether or not each class in the input program is defined by virtual inheritance; a special function consolidating step of generating a code which consolidates at least one of plural constructors and plural destructors of the class, in the case where a result of the virtual inheritance analyzing step shows that the class is not defined by virtual inheritance; and a generating step of generating an object program including the code generated in the special function consolidating step.

According to this method, it is possible to delete a redundantly generated function (particularly a constructor or a destructor) of a class that is not defined by virtual inheritance, regardless of whether or not a class object is generated and regardless of whether or not calling is performed, and thus code generation efficiency increases. Accordingly, it is possible to implement a compiling method which can delete a redundantly generated function, regardless of whether or not a class object is generated and whether or not calling is performed.

It is preferable that in the virtual inheritance analyzing step, whether or not the class is defined by virtual inheritance is analyzed based on a class definition described in the input program.

According to this method, it is possible to delete a redundantly generated constructor and destructor which are functions of a class that is not defined by virtual inheritance, among classes that are not defined in a program, and thus code generation efficiency increases.

In addition, it is preferable that in the virtual inheritance analyzing step, whether or not the class is defined by virtual inheritance is analyzed based on a language specification control statement which is a control statement described in the input program according to a language specification.

According to this method, for example, by having the programmer describe, in the input program, a language specification control statement using a #pragma directive, it is possible to delete a redundantly generated constructor and destructor which are functions of a class that is not defined at high-speed by virtual inheritance, without the need to analyze the class definition originally described in the input program, and thus code generation efficiency increases.

In addition, it is preferable that in the virtual inheritance analyzing step, whether or not the class is defined by virtual inheritance is analyzed based on a language specification control instruction which is a control instruction described according to a language specification of a compiling system compiling the input program.

According to this method, for example, by having the programmer provide a language specification control instruction using an option of the compiler system, it is possible to delete a redundantly generated constructor and destructor which are functions of a class that is not defined at high-speed by virtual inheritance, without the need to analyze the class definition originally described in the input program, and thus code generation efficiency increases.

In addition, it is preferable that in the special function consolidating step, a code which consolidates a full constructor and a partial constructor among plural constructors of the class that is not defined by virtual inheritance is generated, the full constructor being a constructor which is called when generating a full class object which is not a partial class object making up a class object, and the partial constructor being a constructor which is called when generating a partial class object making up a class object. In the special function consolidating step, a code which consolidates a full destructor and a partial destructor among plural destructors of the class that is not defined by virtual inheritance is generated, the full destructor being a destructor which is called when generating a full class object which is not a partial class object making up a class object and the partial destructor being a destructor which is called when generating a partial class object making up a class object.

In addition, it is preferable that in the special function consolidating step, the code which consolidates the full constructor and the partial constructor among the plural constructors of the class that is not defined by virtual inheritance is generated by replacing a call command of one of the full constructor and the partial constructor, with a call command of the other of the full constructor and the partial constructor, and by deleting a constructor code of the one of the full constructor and the partial constructor which is the constructor of the replaced call command. In the special function consolidating step, the code which consolidates the full destructor and the partial destructor among the plural destructors of the class that is not defined by virtual inheritance is generated by replacing a call command of one of the full destructor and the partial destructor, with a call command of the other of the full destructor and the partial destructor, and by deleting a destructor code of the one of the full destructor and the partial destructor which is the destructor of the replaced call command.

In addition, it is preferable that in the special function consolidating step, the code which consolidates the full constructor and the partial constructor among the plural constructors of the class that is not defined by virtual inheritance is generated by deleting a code of one of the full constructor and the partial constructor, and by placing a label indicating a starting address of the full constructor and a label indicating a starting address of the partial constructor, at a start of a code of the other of the full constructor and the partial constructor which is not deleted. In the special function consolidating step, the code which consolidates the full destructor and the partial destructor among the plural destructors of the class that is not defined by virtual inheritance is generated by deleting a code of one of the full destructor and the partial destructor, and by placing a label indicating a starting address of the full destructor and a label indicating a starting address of the partial destructor, at a start of a code of the other of the full destructor and the partial destructor which is not deleted.

According to these methods, it is possible to delete one of a full constructor and a partial constructor which are functions that are redundantly generated, and thus code generation efficiency increases.

It should be noted that the present invention can be implemented not only as a compiling method having such characteristic steps, but also as a compiler apparatus having the characteristic steps included in the compiling method as units, and as a compiler (compiling program) causing a computer to execute the characteristic steps included in the compiling method. Moreover, it should be obvious that such a compiler can be distributed via a storage medium such as a Compact Disc-Read Only Memory (CD-ROM) and so on, or a transmission medium such as the Internet, and so on.

According to the present invention, it becomes possible to provide a compiling method and a compiling program which can delete a redundantly generated function, regardless of whether or not a class object is generated and whether or not calling is performed. Accordingly, the advantageous effect that code generation efficiency improves is achieved.

### FURTHER INFORMATION ABOUT TECHNICAL BACKGROUND TO THIS APPLICATION

The disclosure of Japanese Patent Application No. 2008-009787 filed on Jan. 18, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a flowchart showing an example of processing executed by a compiler in an embodiment of the present invention;

FIG. 2 is a flowchart showing a first example of processing executed in virtual inheritance analysis step S10;

FIG. 3 is a flowchart showing a second example of processing executed in virtual inheritance analysis step S10;

FIG. 4 is a flowchart showing a third example of processing executed in virtual inheritance analysis step S10;

FIG. 5 is a flowchart showing a first example of processing executed in a special function consolidation step S11;

FIG. 6 is a flowchart showing a second example of processing executed in special function consolidation step S11;

FIG. 7 is a diagram showing an example of a source program stored in a program storage unit 1;

FIG. 8 is a diagram showing an assembler output result in the case where compiling is performed according to the conventional method;

FIG. 9 is a diagram showing an assembler output result in the case where compiling is performed according to the conventional method;

FIG. 10 is a diagram showing an assembler output result in the case where compiling is performed according to the conventional method;

FIG. 11 is a diagram showing details of a consolidation target determining flag indicating whether or not the analyzed code is a consolidation target;

FIG. 12 is a diagram showing an assembler output result in the case where compiling is performed according to a method in the present invention;

FIG. 13 is a diagram showing an assembler output result in the case where compiling is performed according to a method in the present invention;

FIG. 14 is a diagram showing an assembler output result in the case where compiling is performed according to a method in the present invention;

FIG. 15 is a diagram showing an assembler output result in the case where compiling is performed according to a method in the present invention;

FIG. 16 is a diagram showing an assembler output result in the case where compiling is performed according to a method in the present invention;

FIG. 17 is a diagram showing an assembler output result in the case where compiling is performed according to a method in the present invention;

### DESCRIPTION OF THE PREFERRED EMBODIMENT(S)

Hereinafter, a compiling method according to an embodiment of the present invention shall be described with reference to the drawings.

It should be noted that the embodiment described below is merely one example of an embodiment of the present invention and does not limit the technical scope of the present invention.

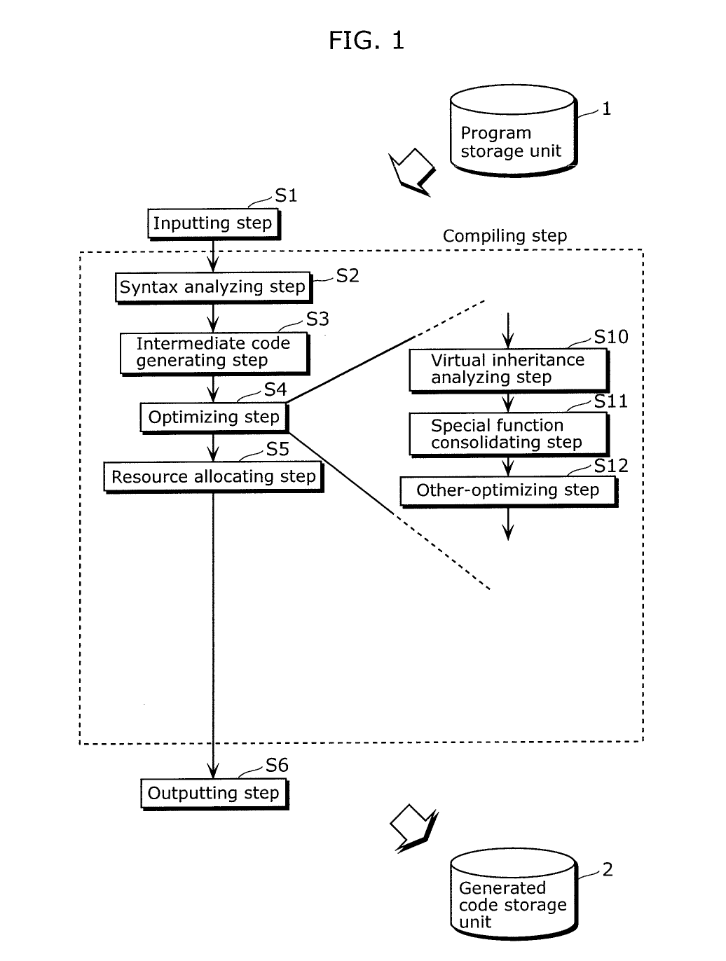

FIG. 1 is a flowchart showing an example of processing executed by a compiler.

Here, a compiler is software (compiling program) which converts a software design (source program) that is described in a programming language by a person, into a computer-executable format (object code).

First, the compiler performs an inputting step (S1) of reading a header file and a source program that are stored in a program storage unit 1, for example.

Next, the compiler performs a syntax analyzing step (S2) of analyzing the syntax of the source program read in the inputting step S1, and generating a symbol table and a syntax tree.

Here, a symbol table is a list made up of all identifiers, their respective attributes and positions within the program, which are detected throughout the analysis, and is a list used by the compiler for judging the usage of the identifiers. Furthermore, a syntax tree is a tree-structure showing the syntax of the programming language.

Next, the compiler performs an intermediate code generating step (S3) of generating an intermediate code based on the generated syntax tree.

Next, the compiler performs an optimizing step (S4) of performing various optimization on the intermediate code generated in the intermediate code generating step S3.

Next, the compiler performs a resource allocating step (S5) of allocating hardware such as registers and memory locations to all variables included in the intermediate code optimized in the optimizing step S4.

Next, the compiler performs an outputting step (S6) of converting the intermediate code to which resources have been allocated in the resource allocating step S5 into an object code, and outputting the object code as an object program to a generated code storage unit 2. The object program outputted in the outputting step S6 is stored in the generated code storage unit 2.

As shown in FIG. 1, the optimizing step S4 includes a virtual inheritance analyzing step S10, a special function consolidating step S11, and an other-optimizing step 12.

In the virtual inheritance analyzing step S10, the intermediate code is analyzed, and analysis is performed as to whether or not each class existing in the program is defined by virtual inheritance.

Here, virtual inheritance is class inheritance means for avoiding ambiguous inheritance of a base class while performing multiple-inheritance of inheriting class behavior from plural parent classes. For example, when there are two classes inheriting from a certain class, and multiple inheritance of the two classes is performed, this means that the source class (base class) is inherited twice. In virtual inheritance, the base class which is the source class which is inherited twice is declared as a virtual basic class, and the ambiguity of inheritance is prevented by not distinguishing the instances of the virtual basic class.

In the special function consolidating step S11, plural constructors or plural destructors generated redundantly are consolidated, according to the analysis result in the virtual inheritance analyzing step S10.

Here, a constructor is a function which is called when creating a new object in an object-oriented programming language, and which performs initialization of an object, and the like. Furthermore, a destructor is a function which is called when deleting an object in an object-oriented programming language, and which performs post-processing and the like.

Details of the virtual inheritance analyzing step S10 and the special function consolidating step S11 shall be described later.

It should be noted that the other-optimizing step S12 is a general optimizing step and, since it is not a main point of the present invention, description thereof shall be omitted.

Furthermore, the inputting step S1, the syntax analyzing step S2, the intermediate code generating step S3, the resource allocating step S5, the object outputting step S6, and the other-optimizing step S12 are processes which are the same as existing processes, and are not the focus of the present invention. As such, their detailed description shall be omitted.

Furthermore, the virtual inheritance analyzing step S10 and the special function consolidating step S11 are not necessarily limited to the optimizing step S4 between the intermediate code generating step S3 and the resource allocating step S5, and may be performed within any interval (within intervals S1 to S6), as long as analyzing and consolidating within the compiling step is possible.

Hereinafter, the virtual inheritance analyzing step S10 and the special function consolidating step S11, which are the focus of the present invention, shall be described.

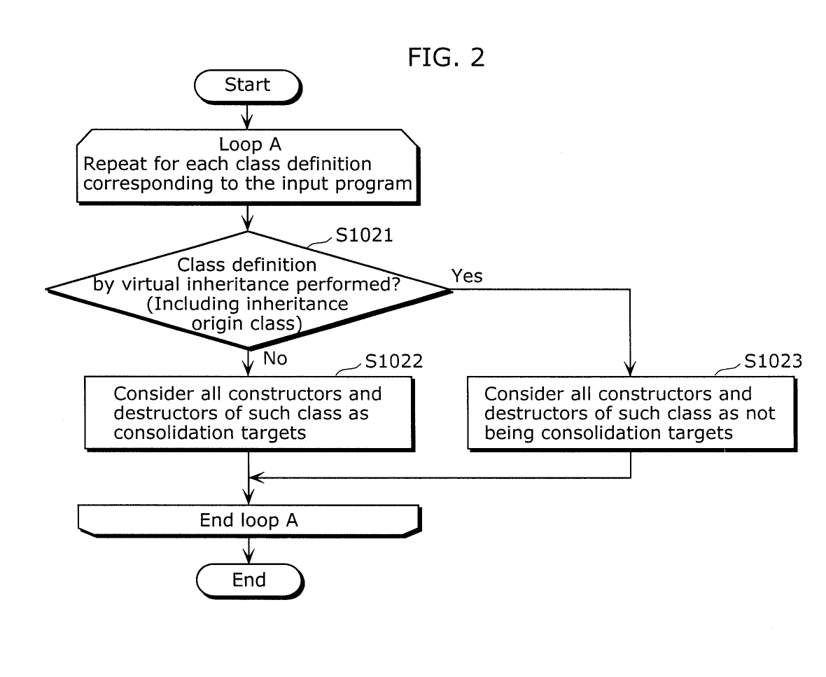

FIG. 2 is a flowchart showing a first example of processing executed in the virtual inheritance analysis step S10.

In the virtual inheritance analysis step S10, the following processing (described as loop A in FIG. 2) is repeated for each of class definitions corresponding to a source program (input program) inputted in the inputting step St, that is, for each of class definitions described in an intermediate code generated in the intermediate code generating step S3.

First, the input program is checked for whether or not a class definition which is an analysis target exists.

When an analysis target (class definition) exists, each class described in the intermediate code (including the inheritance origin class) is analyzed for whether or not class definition has been performed using virtual inheritance (S1021).

When class definition has not been performed using virtual inheritance (No in S1021), all the constructors or destructors of the analyzed class are considered to be consolidation targets (S1022). This can be controlled, for example, through a consolidation determining flag indicating that the class is a consolidation target.

When class definition has been performed using virtual inheritance (Yes in S1021), all the constructors or destructors of the analyzed class are not considered as consolidation targets (S1023). This can be controlled, for example, through a consolidation determining flag indicating that the class is not consolidation target.

Next, the input program is checked for whether or not another class definition which is an unanalyzed analysis target exists. When another class definition which is an unanalyzed analysis target exists, loop A is repeated until no more analysis target class definitions exist. When another class definition which is an unanalyzed analysis target does not exist, loop A ends, and thus the processing ends.

As described above, in the virtual inheritance analyzing step S10, the intermediate code is analyzed, and analysis is performed as to whether or not each class existing in the program is defined using virtual inheritance.

It should be noted that the form of the information indicating whether or not a class is a consolidation target may be data in the intermediate code or independent data associated with the class, as long as the data can be referred to in the special function consolidating step S11.

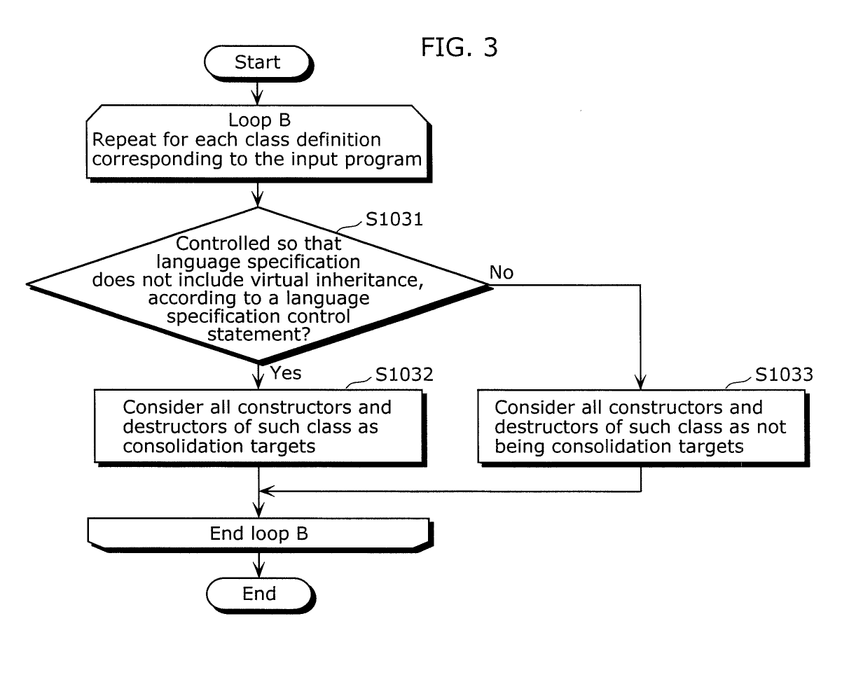

FIG. 3 is a flowchart showing a second example of processing executed in the virtual inheritance analysis step S10.

In the virtual inheritance analysis step S10, the following processing (described as loop B in FIG. 3) is repeated for each of class definitions corresponding to the input program, as in FIG. 2.

First, the input program is checked for whether or not a class definition which is an analysis target exists.

When an analysis target (class definition) exists, analysis is performed for whether or not the language specification in the description in the input program is controlled so that the language specification does not include virtual inheritance, according to a language specification control statement (S1031). Here, a language specification control statement is a control statement described in the input program in accordance with a language specification. For example, by describing, in the source program, a control statement for instructing the enabling of a special function prepared in the language specification, such as a #pragma directive, control for directly providing information regarding language specification to the compiler is performed.

When the language specification in the description in the input program is controlled so that the language specification does not include virtual inheritance, according to a language specification control statement (Yes in S1031), all the constructors or destructors of such class are considered as consolidation targets (S1032).

When not, that is, when the language specification in the description in the input program is controlled so that the language specification includes virtual inheritance, according to a language specification control statement (No in S1031), all the constructors or destructors of such class are not considered as consolidation targets (S1033).

Next, the input program is checked for whether or not another class definition which is an unanalyzed analysis target exists. When another class definition which is an unanalyzed analysis target exists, loop B is repeated until no more analysis target class definitions exist. When another class definition which is an unanalyzed analysis target does not exist, loop B ends, and thus the processing ends.

As described above, in the virtual inheritance analyzing step S10, the intermediate code is analyzed, and analysis is performed as to whether or not classes existing in the program are defined by virtual inheritance.

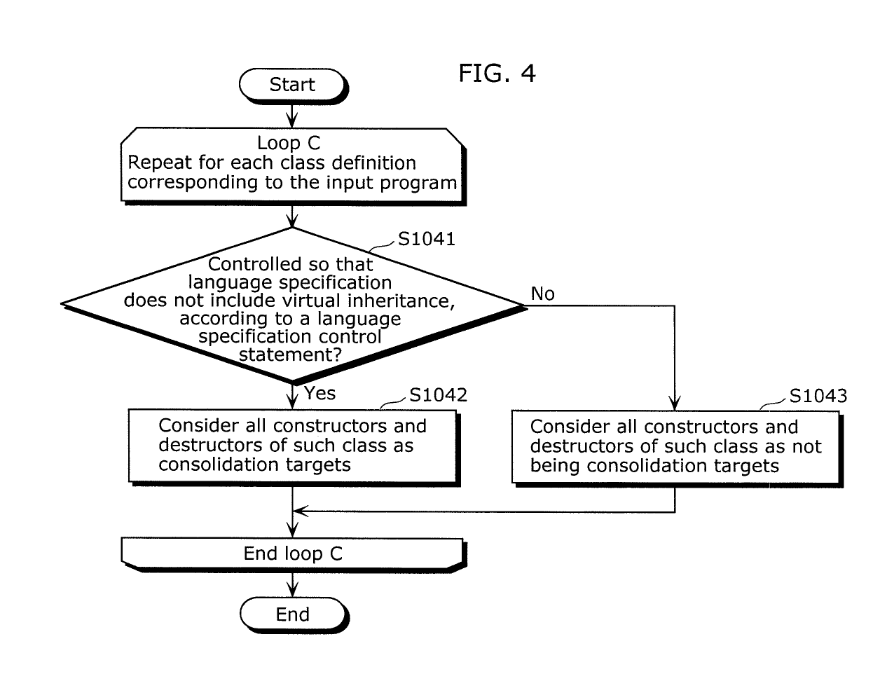

FIG. 4 is a flowchart showing a third example of processing executed in the virtual inheritance analysis step S10.

In the virtual inheritance analysis step S10, the following processing (described as loop C in FIG. 3) is repeated for each of class definitions corresponding to the input program, as in FIG. 3.

First, the input program is checked for whether or not a class definition which is an analysis target exists.

When an analysis target (class definition) exists, analysis is performed for whether or not the language specification in the description in the input program is controlled so that the language specification does not include virtual inheritance, according to a language specification control statement (S1041). Here, a language specification control statement is a control instruction described in accordance with a language specification of the compiler system compiling the input program. For example, by describing, in the source program, a command for instructing the enabling of a special function prepared in the compiler, such as a command line option, control for directly providing information regarding language specification to the compiler system is performed

When the language specification in the description in the input program is controlled so that the language specification does not include virtual inheritance, according to a language specification control statement (Yes in S1041), all the constructors or destructors of such class are considered as consolidation targets (S1042).

When not, that is, when the language specification in the description in the input program is controlled so that the language specification includes virtual inheritance, according to a language specification control statement (No in S1041), all the constructors or destructors of such class are not considered as consolidation targets (S1043).

Next, the input program is checked for whether or not another class definition which is an unanalyzed analysis target exists. When another class definition which is an unanalyzed analysis target exists, loop C is repeated until no more analysis target class definitions exist. When another class definition which is an unanalyzed analysis target does not exist, loop C ends, and thus the processing ends.

As described above, in the virtual inheritance analyzing step S10, the intermediate code is analyzed, and analysis is performed as to whether or not classes existing in the program are defined by virtual inheritance.

It should be noted that, by assigning priority levels, for example, the first to third processing in the virtual inheritance analyzing step S10 described from FIG. 2 to FIG. 4 may also be a single virtual inheritance analyzing step S10 including all the steps from FIG. 2 to FIG. 4; and combinations may also be selected freely.

Next, the special function consolidation step S11 is described.

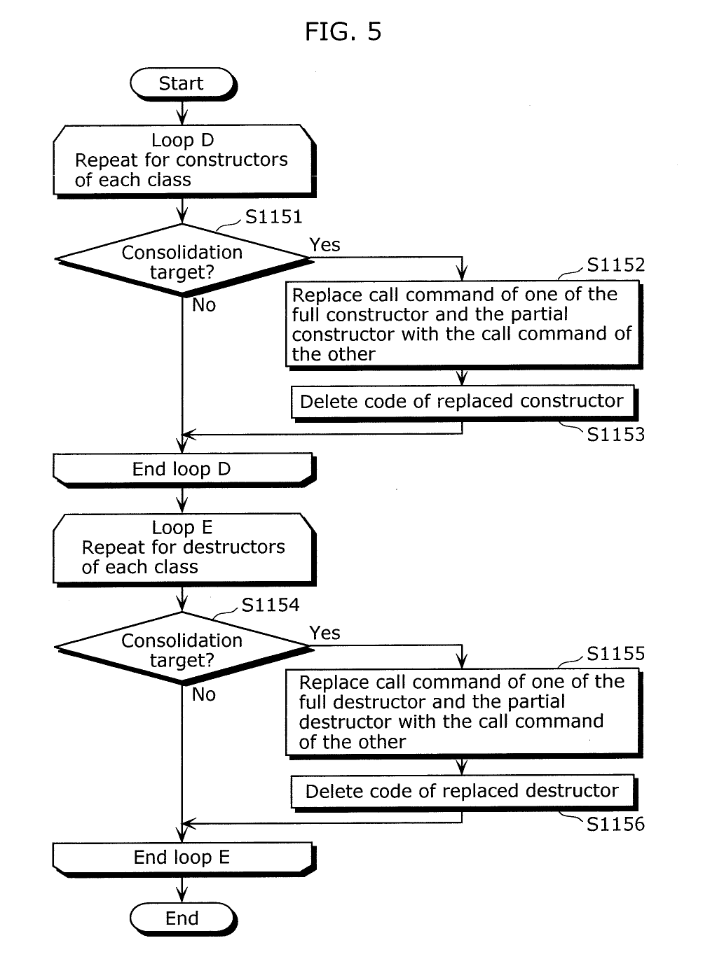

FIG. 5 is a flowchart showing a first example of processing executed in the special function consolidation step S11.

In the special function consolidating step S11, processing of the constructors (loop D) and processing of the destructors (loop E) of each class described in the intermediate code generated in the intermediate code generating step S3 is performed according to the analysis result in the virtual inheritance analyzing step S10.

First, each class described in the intermediate code analyzed in the virtual inheritance analyzing step S10 is checked for whether or not a constructor exists.

When a constructor exists, it is determined whether or not such constructor is a consolidation target (S1151).

When such constructor is a consolidation target (Yes in S1151), the call command of one of a full constructor and a partial constructor for such constructor is replaced with the call command of other (S1152). Then, the code of the replaced (full or partial) constructor is deleted (S1153).

Here, a full constructor refers to a constructor that is called when generating a full class object which is not a partial class object making up a class object. Furthermore, a partial constructor refers to a constructor that is called when generating a partial class object which makes up a class object.

Next, each class described in the intermediate code analyzed in the virtual inheritance analyzing step S10 is checked for whether or not a constructor still exists. When a constructor still exists, the processing shown in loop D is repeated for the constructors of each class. When a constructor does not exist, loop D ends, and thus the processing shown in loop D ends.

Furthermore, in S1151, when the constructor is not a consolidation target, nothing is done (No in S1151). Then, the processing in loop D ends.

Next, the processing of the destructors shown in loop E is performed.

First, each class described in the intermediate code analyzed in the virtual inheritance analyzing step S10 is checked for whether or not a destructor exists.

When a destructor exists, it is determined whether or not such destructor is a consolidation target (S1154).

When such destructor is a consolidation target (Yes in S1154), the call command of one of a full destructor and a partial destructor for such destructor is replaced with the call command of the other (S1155). Then, the code of the replaced (full or partial) destructor is deleted (S1156).

Here, a full destructor refers to a destructor that is called when generating a full class object which is not a partial class object making up a class object. Furthermore, a partial destructor refers to a destructor that is called when generating a partial class object which makes up a class object.

Next, each class described in the intermediate code analyzed in the virtual inheritance analyzing step S10 is checked for whether or not a destructor still exists. When a destructor still exists, the processing shown in loop E is repeated for the destructors of each class. When a destructor does not exist, loop E ends, and thus the processing shown in loop E ends.

Furthermore, in S1154, when the destructor is not a consolidation target, nothing is done (No in S1154). Then, the processing in loop E ends.

As described above, in the special function consolidating step S11, plural constructors or plural destructors generated redundantly are consolidated, according to the analysis result in the virtual inheritance analyzing step S10. With this, it is possible to delete one of the full constructor and the partial constructor which is a function that has been generated redundantly, and thus code generation efficiency improves.

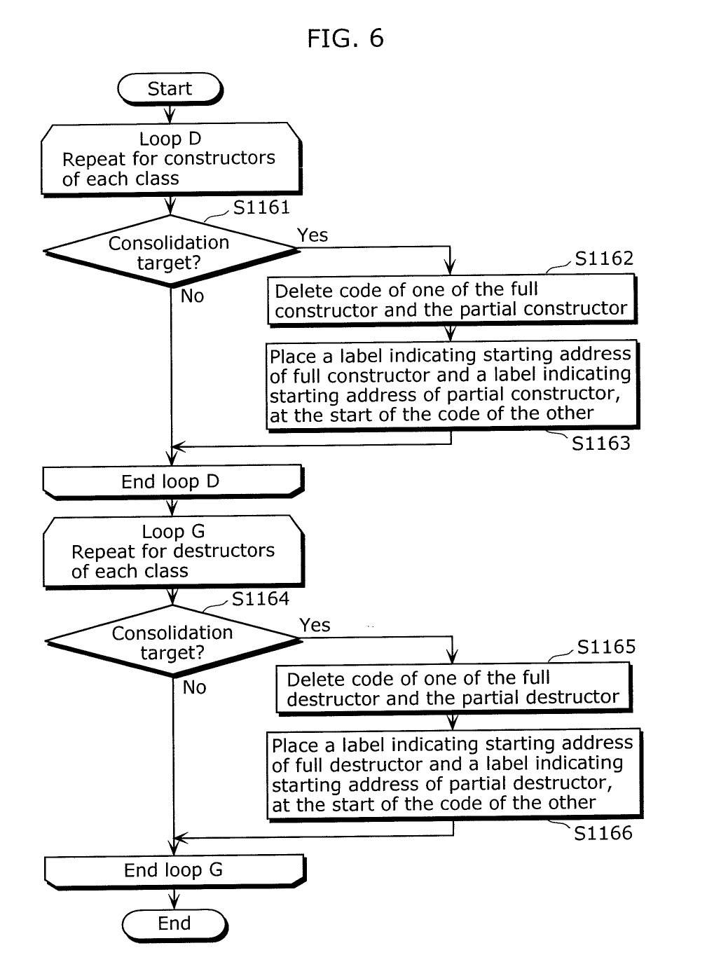

FIG. 6 is a flowchart showing a second example of processing executed in the special function consolidation step S11.

As in FIG. 5, in the special function consolidating step S11, processing of the constructors (loop F) and processing of the destructors (loop G) of each class described in the intermediate code generated in the intermediate code generating step S3 is performed according to the analysis result in the virtual inheritance analyzing step S10.

First, each class described in the intermediate code analyzed in the virtual inheritance analyzing step S10 is checked for whether or not a constructor exists.

When a constructor exists, it is determined whether or not such constructor is a consolidation target (S1161).

When such constructor is a consolidation target (Yes in S1161), the code of one of a full constructor and a partial constructor for such constructor is deleted (S1162). Then, a label indicating the starting address of the full constructor and a label indicating the starting address of the partial constructor are placed at the start of the code of the other of the full constructor and the partial constructor (S1163).

Next, each class described in the intermediate code analyzed in the virtual inheritance analyzing step S10 is checked for whether or not a constructor still exists. When a constructor still exists, the processing shown in loop F is repeated for the constructors of each class. When a constructor does not exist, loop F ends, and thus the processing shown in loop F ends.

Furthermore, in S1161, when the constructor is not a consolidation target, nothing is done (No in S1161). Then, the processing in loop F ends.

Next, the processing of the destructors shown in loop G is performed.

First, each class described in the intermediate code analyzed in the virtual inheritance analyzing step S10 is checked for whether or not a destructor exists.

When a destructor exists, it is determined whether or not such destructor is a consolidation target (S1164).

When such destructor is a consolidation target (Yes in S1164), the code of one of a full destructor and a partial destructor for such destructor is deleted (S1165). Then, a label indicating the starting address of the full destructor and a label indicating the starting address of the partial destructor are placed at the start of the code of the other of the full destructor and the partial destructor (S1165).

Next, each class described in the intermediate code analyzed in the virtual inheritance analyzing step S10 is checked for whether or not a destructor still exists. When a destructor still exists, the processing shown in loop G is repeated for the destructors of each class. When a destructor does not exist, loop G ends, and thus the processing shown in loop G ends.

Furthermore, in S1164, when the destructor is not a consolidation target, nothing is done (No in S1164). Then, the processing in loop G ends.

As described above, in the special function consolidating step S11, plural constructors or plural destructors generated redundantly are consolidated, according to the analysis result in the virtual inheritance analyzing step S10. With this, it is possible to delete one of the full constructor and the partial constructor which is a function that has been generated redundantly, and thus code generation efficiency improves.

Thus, by performing the optimizing step S4 including the virtual inheritance analyzing step S10 and the special function consolidation step S11, it is possible to delete a redundantly generated function (particularly a constructor or a destructor) of a class that is not defined by virtual inheritance, regardless of whether or not a class object is generated and regardless of whether or not calling is performed, and thus code generation efficiency increases. Accordingly, it is possible to implement a compiling method which can delete a redundantly generated function, regardless of whether or not a class object is generated or whether or not calling is performed.

### EXAMPLES

Hereinafter, the compiling method according to the present invention shall be described by showing an example using the C++ language.

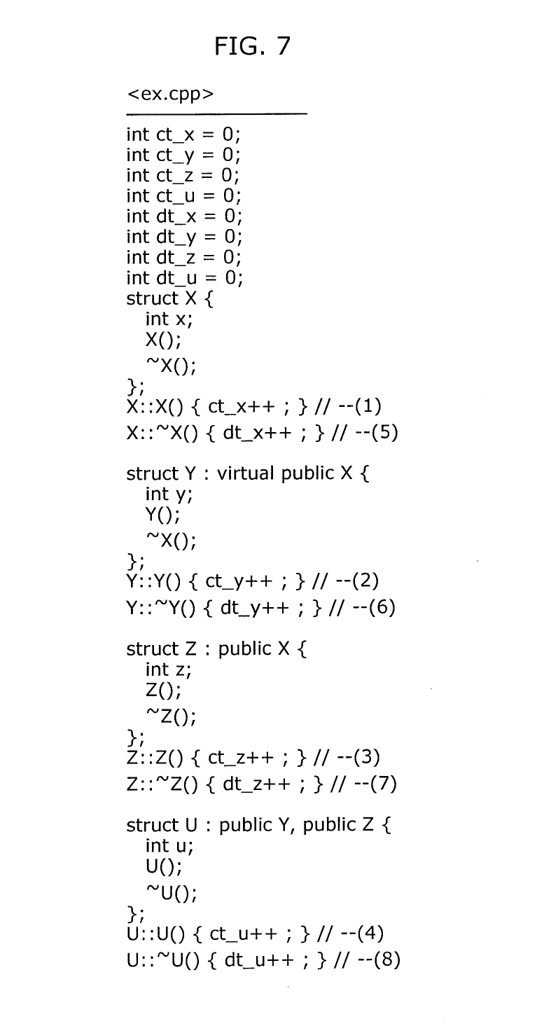

FIG. 7 is a diagram showing an example of a source program stored in the program storage unit 1.

The compiling method in the case where the source program shown in FIG. 7 is inputted is described below. Here, as a premise, it is assumed that <ex.cpp> is compiled according to the C++ mode.

In the source file <ex.cpp> shown in FIG. 7, four classes (X, Y, Z, U) are defined. In FIG. 7, for the four classes (X, Y, Z, U), respective constructors are defined by being indicated by (1) to (4). In the same manner, for the four classes (X, Y, Z, U), respective destructors are defined by being indicated by (5) to (8).

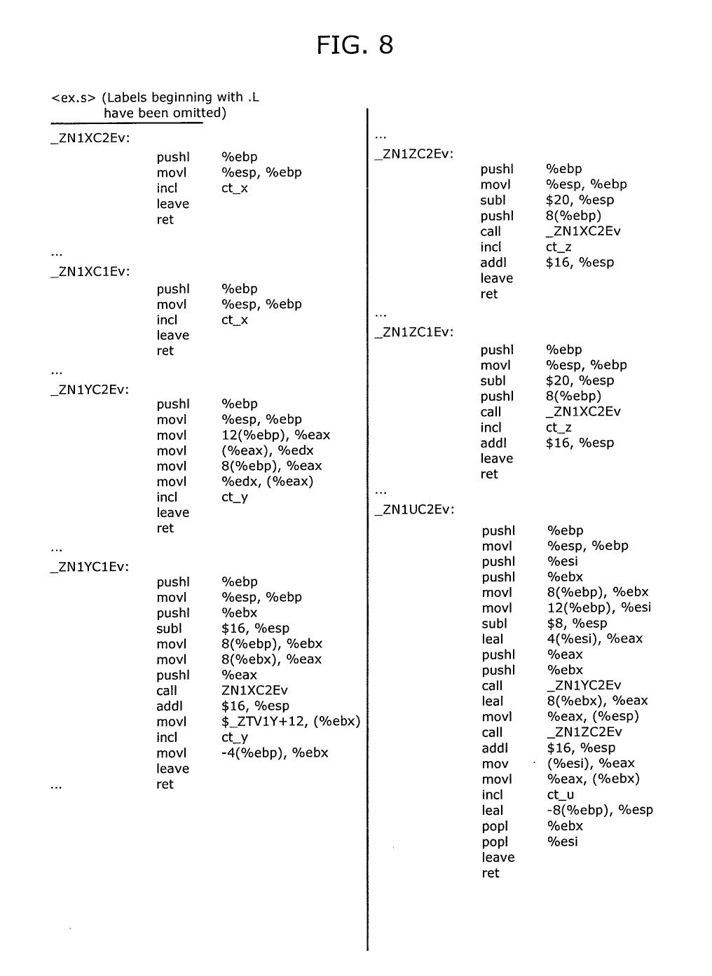

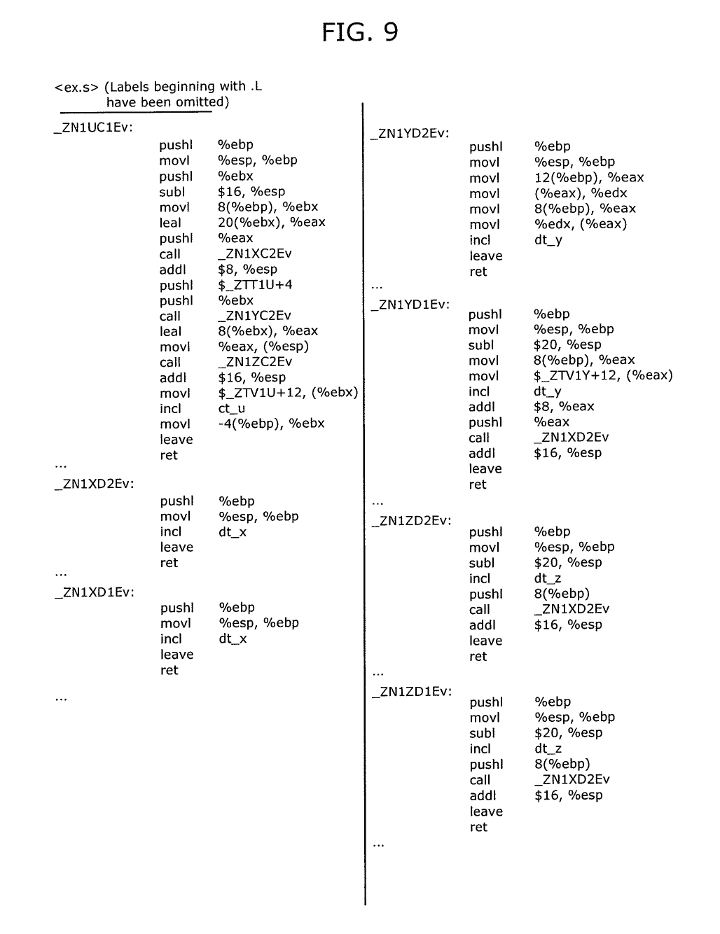

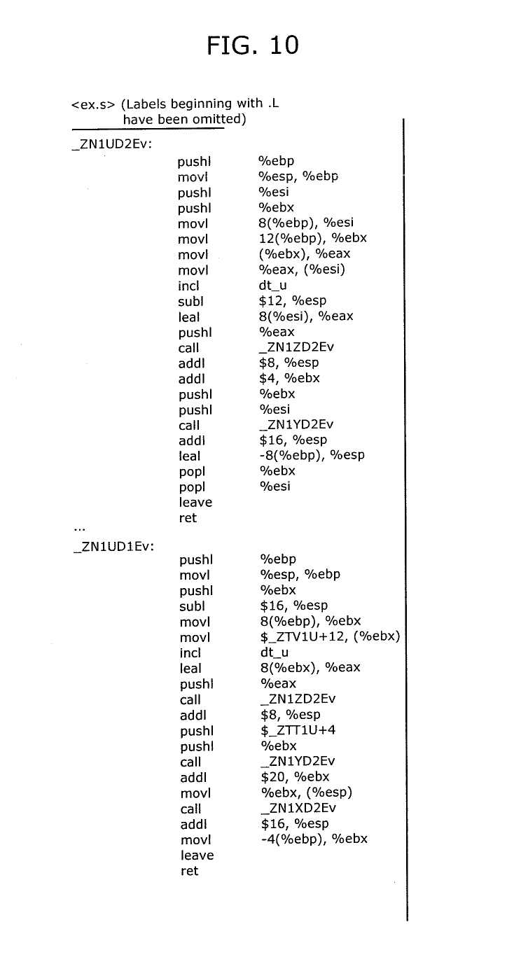

FIG. 8 to FIG. 10 are diagrams showing an assembler output result in the case where compiling is performed according to the conventional method; Furthermore, FIG. 8 to FIG. 10 show the assembler output result in the case where an optimization option “-O” is added using a gcc version 3.3.6 release compiler. Here, in order to simplify the following description, labels beginning with “.L” are excluded.

In the conventional method, as shown in FIG. 8 to FIG. 10, the constructor definitions and the destructor definitions of each class are unconditionally converted into full constructors and partial constructors, and full destructors and partial destructors, respectively. The association of the constructors and destructors shown in FIG. 7, and the full constructors and partial constructors and the full destructors and partial destructors shown in FIG. 8 to FIG. 10 is as indicated in [Table 1] and [Table 2] below.

TABLE 1

| | Constructor | | Full constructor | Partial constructor |
|---|---|---|---|---|
| (1) | X::X( ) | → | _ZN1XC1Ev | _ZN1XC2Ev |
| (2) | Y::Y( ) | → | _ZN1YC1Ev | _ZN1YC2Ev |
| (3) | Z::Z( ) | → | _ZN1ZC1Ev | _ZN1ZC2Ev |
| (4) | U::U( ) | → | _ZN1UC1Ev | _ZN1UC2Ev |

TABLE 2

| | Destructor | | Full destructor | Partial destructor |
|---|---|---|---|---|
| (1) | X::~X( ) | → | _ZN1XD1Ev | _ZN1XD2Ev |
| (2) | Y::~Y( ) | → | _ZN1YD1Ev | _ZN1YD2Ev |
| (3) | Z::~Z( ) | → | _ZN1ZD1Ev | _ZN1ZD2Ev |
| (4) | U::~U( ) | → | _ZN1UD1Ev | _ZN1UD2Ev |

It can be seen from FIG. 8 to FIG. 10 that with each of the codes “_ZN1XC1Ev” and “_Z1XC2Ev”, and the codes “_ZN1ZC1Ev” and “_ZN1ZC2Ev”, and the codes “_ZN1XD1Ev” and “_Z1XD2Ev”, and the codes “ZN1ZD1Ev” and “_ZN1ZD2Ev”, exactly the same assembly codes are generated, and the codes are redundantly generated.

Next, an example using the C++ language is shown for the compiling method according to the present embodiment.

The processing in loop A shown in FIG. 2 is performed on the intermediate code generated in the intermediate code generating step, for each class definition, in the virtual inheritance analyzing step S10. In the present example, the four class definitions (X, Y, Z, U) shown in FIG. 7 are targeted.

In FIG. 7, since class definition by virtual inheritance has not been performed on class X, constructor “X::X( )” and destructor “X::˜X( )” of class X are recorded as consolidation targets.

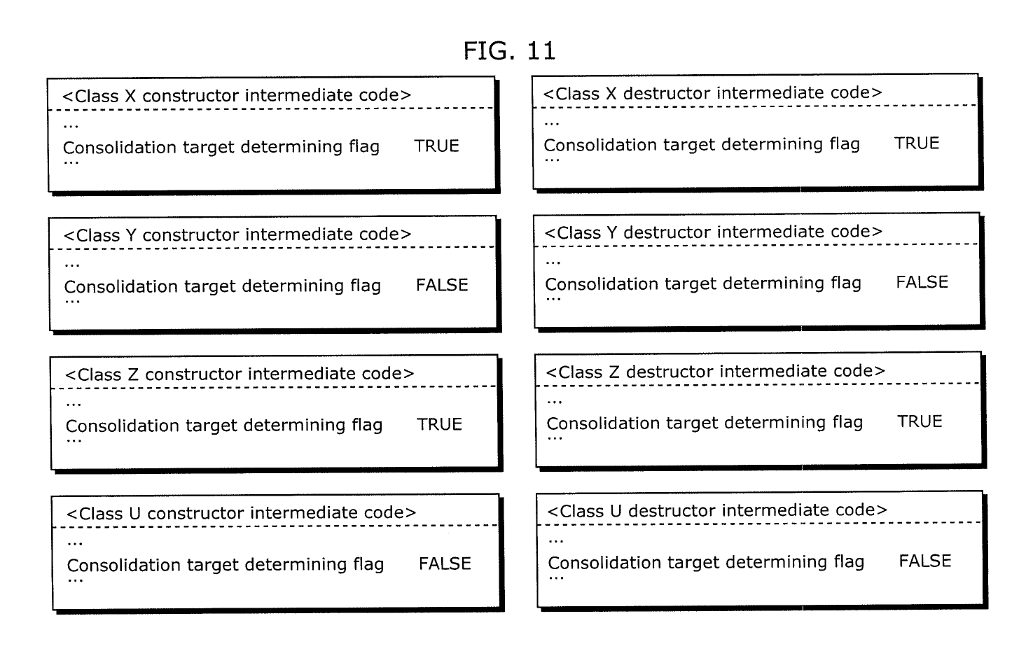

FIG. 11 is a diagram showing details of a consolidation target determining flag indicating whether or not the analyzed code is a consolidation target.

As shown in FIG. 11, “TRUE” is recorded in the consolidation target determining flags of the class X constructor intermediate code and the class X destructor intermediate code. In this manner, by recording a consolidation target determining flag indicating a consolidation target, the constructor “X::X( )” and the destructor “X::˜X( )” of class X are recorded as consolidation targets.

Furthermore, in FIG. 7, since class definition by virtual inheritance from class X has been performed on class Y using a keyword “virtual”, contractor “Y::Y( )” and destructor “Y::˜Y( )” of class Y are recorded as not being consolidation targets.

Here, as shown in FIG. 11 for example, by recording “FALSE” in the consolidation target determining flags of the class Y constructor intermediate code and the class Y destructor intermediate code, the fact that they are not consolidation targets is recorded.

Furthermore, in FIG. 7, class Z inherits from class X without using virtual inheritance and, in addition, class definition by virtual inheritance has not been performed on the inheritance origin class X, and thus constructor “Z::Z( )” and destructor “Z::Z˜( )” of class Z are recorded as consolidation targets.

Here, as shown in FIG. 11 for example, by recording “TRUE” in the consolidation target determining flags of the class Z constructor intermediate code and the class Z destructor intermediate code, the fact that they are consolidation targets is recorded.

Furthermore, in FIG. 7, although class U inherits from class Y and class Z without using virtual inheritance, class Y which is an inheritance origin is classified by virtual inheritance. Therefore, constructor “U::U( )” and destructor “U::˜U( )” of class U are recorded as not being consolidation targets.

Here, as shown in FIG. 11 for example, by recording “FALSE” in the consolidation target determining flags of the class U constructor intermediate code and the class U destructor intermediate code, the fact that they are not consolidation targets is recorded.

It should be noted that the consolidation target determining flag shown in FIG. 11 is one form of the information indicating whether or not the analyzed code is a consolidation target, and such information may also be data in the intermediate code as in the above-described example, or independent data associated with the class, as long as the data can be referred to in the special function consolidating step S11.

Next, the special function consolidating step S11 is performed according to the analysis result in the virtual inheritance analyzing step S10 described above.

In the first example of the processing executed in the special function consolidation step S11 in FIG. 5, the processing in loop D and the processing in loop E are performed. In the present example, in the special function consolidation step S11, the plural constructors or plural destructors that have been generated redundantly, based on the analysis result in the virtual inheritance analysis step S10, are consolidated by referring to the consolidation target determining flag shown in FIG. 11. Based on FIG. 11, the constructors and destructors of class X and class Z are consolidation targets.

As such, after replacing the call command of one of the full constructor and the partial constructor with the call command of the other, the code of the replaced constructor is deleted.

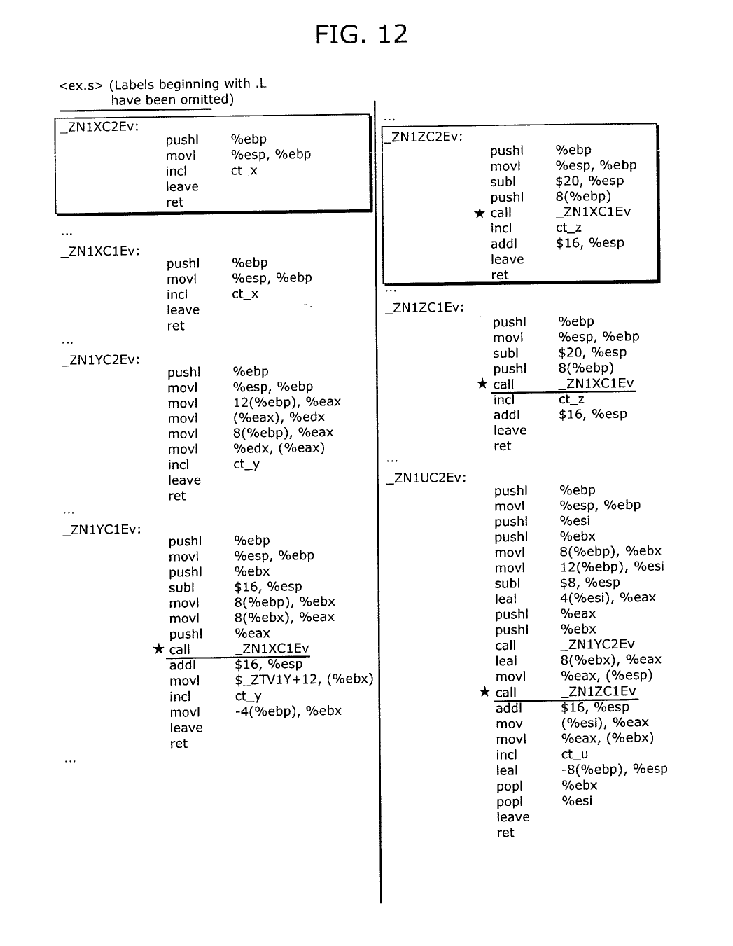

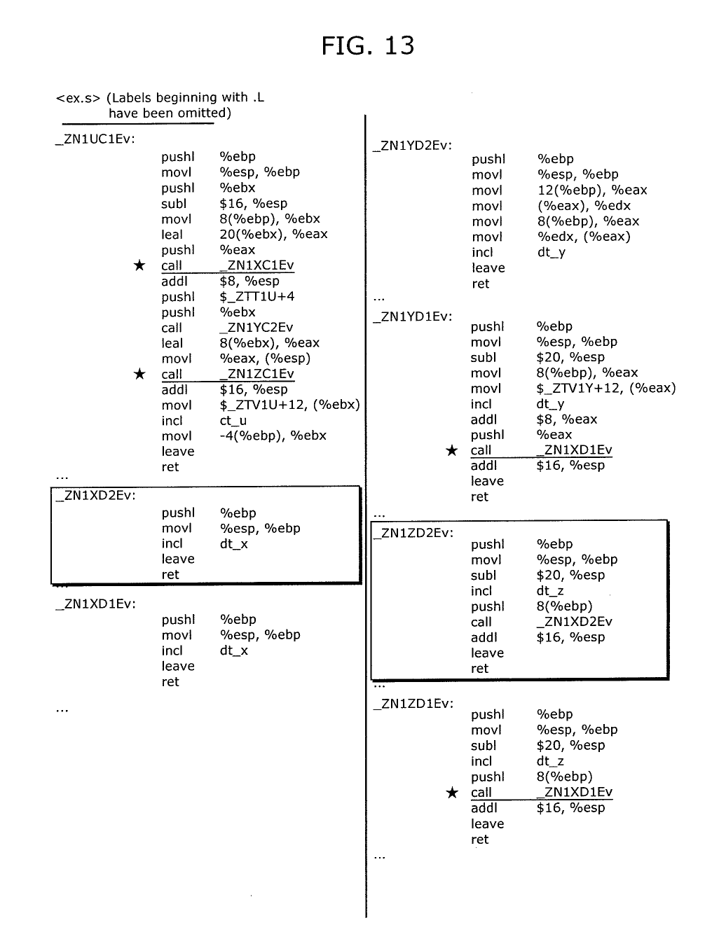

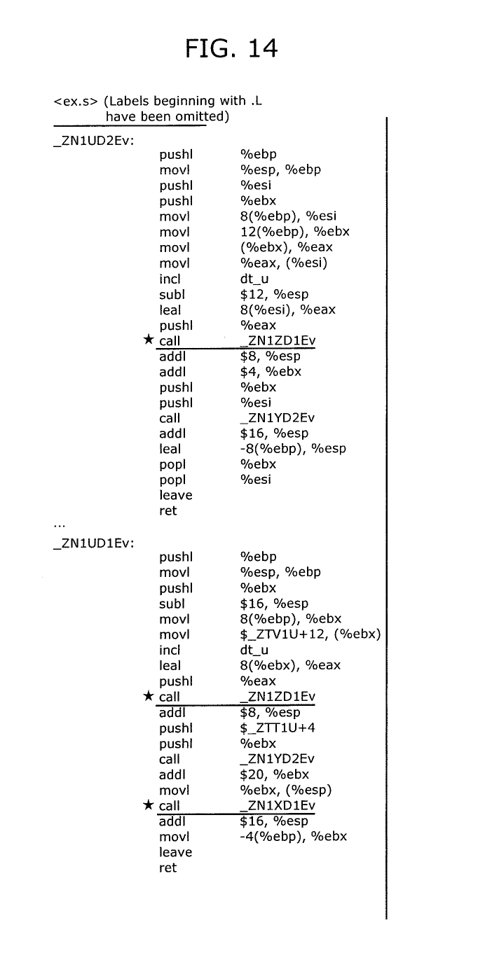

In the present example, the partial constructor call command is replaced with the full constructor call command, and the partial constructor is deleted (processing in loop D). The same processing is also performed for the destructor (processing in loop E). The results of performing the above-described processing are shown in FIG. 12 to FIG. 14.

FIG. 12 to FIG. 14 are diagrams showing an assembler output result in the case where compiling is performed according to the method in the present invention.

The areas marked with a star symbol and underline in the diagrams are the replaced full constructor call commands and full destructor call commands.

Furthermore, the boxed-in portions are the partial constructor codes and partial destructor codes that are deleted in the special function consolidation step S11.

Based on the assembler output results in FIG. 12 to FIG. 14, it can be seen that redundant codes have been deleted.

Furthermore, the special function consolidation step S11 in the second example in FIG. 6 is described below. In the second example of the processing executed in the special function consolidation step S11 in FIG. 6, the processing in loop F and the processing in loop G are performed first. As in FIG. 5, in the present example, in the special function consolidation step S11, the plural constructors and plural destructors that have been generated redundantly, based on the analysis report of the virtual inheritance analysis step S10, are consolidated by referring to the consolidation target determining flag shown in FIG. 11. Based on FIG. 11, the constructors and destructors of class X and class Z are consolidation targets.

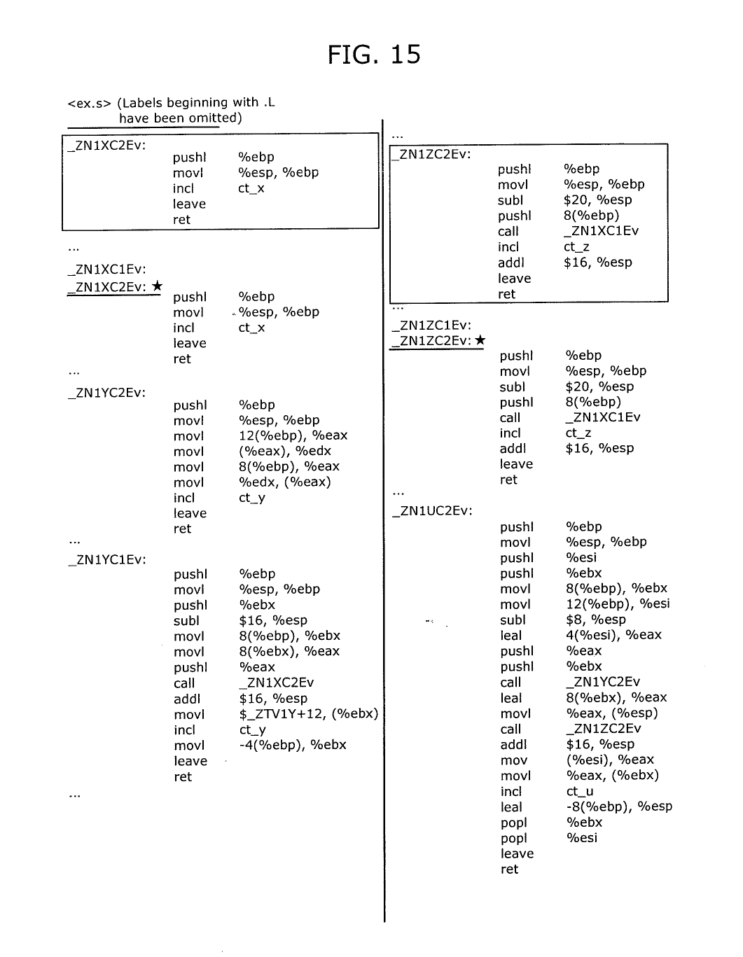

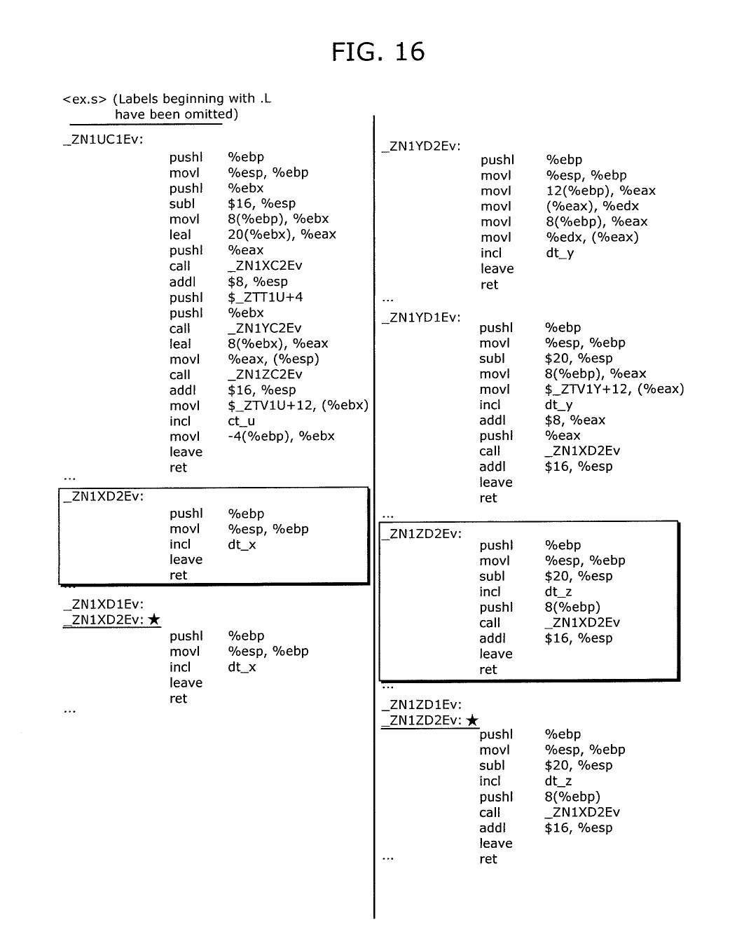

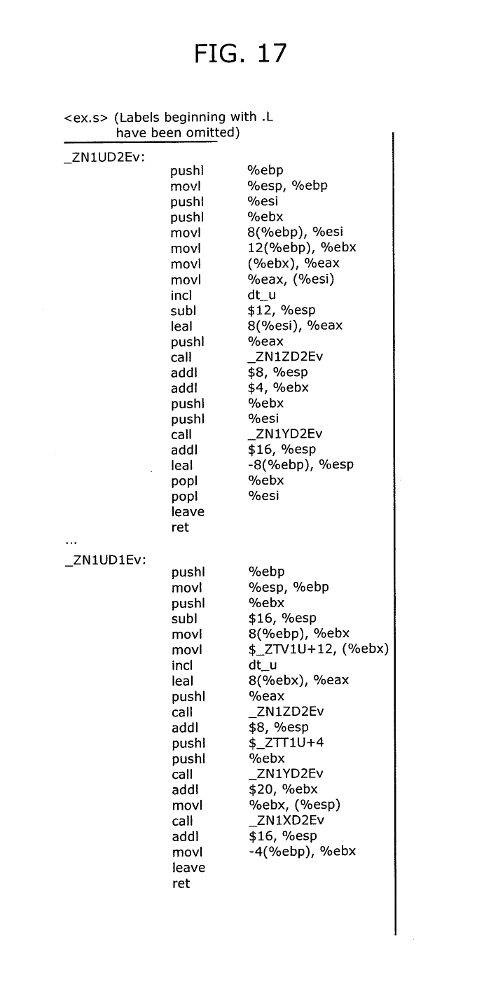

As such, after deleting the code of one of the full constructor and the partial constructor, a label indicating the starting address of the full constructor and a label indicating the starting address of the partial constructor are placed at the start of the code of the other. In the present specific example, the partial constructor is deleted (processing in loop F). The same processing is also performed for the destructor (processing in loop G). The results of performing the above-described processing are shown in FIG. 15 to FIG. 17.

FIG. 15 to FIG. 17 are diagrams showing an assembler output result in the case where compiling is performed according to the method in the present invention.

The boxed-in portions in the diagrams are the deleted partial constructor codes and partial destructor codes, and the areas marked with a star symbol and underline are the newly placed labels indicating the starting addresses of the partial constructor or the partial destructor.

Based on the assembler output results in FIG. 15 to FIG. 17, it can be seen that redundant codes have been deleted.

It should be noted that in the case of the processing shown in FIG. 3 and FIG. 4, the virtual inheritance analyzing step S10 is the same as in FIG. 2, except for considering the constructor and destructor as consolidation targets according on whether or not the language specification controlled by the user includes virtual inheritance.

As a specific example of the processing shown in FIG. 3, in the case where, for example, a language specification control statement such as “#pragma_embedded_c++” which is a pragma that guarantees description in the EC++ (embedded_c++) language specification, exists in the program, the constructors and destructors of all the classes are considered as consolidation targets, since virtual inheritance departs from the EC++ language specification. Therefore, in the same manner as the above-described example, the redundant codes can be deleted by performing the special function consolidating step S11.

As a specific example of the processing shown in FIG. 4, in the case where, for example, the compiler is provided with a language specification control instruction such as “--embedded_c++” which is an option that specifies the performance of compiling in the EC++ language mode, the constructors and destructors of all the classes are considered as consolidation targets, since virtual inheritance departs from the EC++ language specification. Therefore, in the same manner as described above, the redundant codes can be deleted by performing the special function consolidating step S11.

As described thus far, according to the compiling method and compiling program of the present invention, by performing the optimizing step S4 which includes the virtual inheritance analyzing step S10 and the special function consolidation step S11, it is possible to implement a compiling method which can delete a redundantly generated function, regardless of whether or not a class object is generated and whether or not calling is performed.

Although the compiling method and compiling program of the present invention have been described thus far based on the embodiment, the present invention is not limited to such embodiment. Various modifications to the present embodiment that can be conceived by those skilled in the art, and forms configured by combining processing details in different embodiments without departing from the teachings of the present invention are included in the scope of the present invention.

### INDUSTRIAL APPLICABILITY

The present invention can be used in compiling methods and compiling programs, and particularly in a compiling method and a compiling program for an embedded device requiring object codes having a small code-size, such as a mobile phone or Personal Digital Assistant (PDA).

What is claimed is:

1. A compiling method for converting, into an object program, an input program written in an object-oriented language and having at least one class, said compiling method comprising:
a virtual inheritance analyzing step of analyzing whether or not each class in the input program is defined by virtual inheritance;
a special function consolidating step of generating a code which consolidates at least one of plural constructors and plural destructors of the class, in the case where a result of said virtual inheritance analyzing step shows that the class is not defined by virtual inheritance; and
a generating step of generating an object program including the code generated in the special function consolidating step.

2. The compiling method according to claim 1,
wherein, in said virtual inheritance analyzing step, whether or not the class is defined by virtual inheritance is analyzed based on a class definition described in the input program.

3. The compiling method according to claim 1,
wherein, in said virtual inheritance analyzing step, whether or not the class is defined by virtual inheritance is analyzed based on a language specification control statement which is a control statement described in the input program according to a language specification.

4. The compiling method according to claim 1,
wherein, in said virtual inheritance analyzing step, whether or not the class is defined by virtual inheritance is analyzed based on a language specification control instruction which is a control instruction described according to a language specification of a compiling system compiling the input program.

5. The compiling method according to claim 1,
wherein, in said special function consolidating step, a code which consolidates a full constructor and a partial constructor among plural constructors of the class that is not defined by virtual inheritance is generated, the full constructor being a constructor which is called when generating a full class object which is not a partial class object making up a class object, and the partial constructor being a constructor which is called when generating a partial class object making up a class object.

6. The compiling method according to claim 5,
wherein, in said special function consolidating step, a code which consolidates a full destructor and a partial destructor among plural destructors of the class that is not defined by virtual inheritance is generated, the full destructor being a destructor which is called when generating a full class object which is not a partial class object making up a class object and the partial destructor being a destructor which is called when generating a partial class object making up a class object.

7. The compiling method according to claim 1,
wherein, in said special function consolidating step, the code which consolidates the full constructor and the partial constructor among the plural constructors of the class that is not defined by virtual inheritance is generated by replacing a call command of one of the full constructor and the partial constructor, with a call command of the other of the full constructor and the partial constructor, and by deleting a constructor code of the one of the full constructor and the partial constructor which is the constructor of the replaced call command.

8. The compiling method according to claim 7,
wherein, in said special function consolidating step, the code which consolidates the full destructor and the partial destructor among the plural destructors of the class that is not defined by virtual inheritance is generated by replacing a call command of one of the full destructor and the partial destructor, with a call command of the other of the full destructor and the partial destructor, and by deleting a destructor code of the one of the full destructor and the partial destructor which is the destructor of the replaced call command.

9. The compiling method according to claim 1,
wherein, in said special function consolidating step, the code which consolidates the full constructor and the partial constructor among the plural constructors of the class that is not defined by virtual inheritance is generated by deleting a code of one of the full constructor and the partial constructor, and by placing a label indicating a starting address of the full constructor and a label indicating a starting address of the partial constructor, at a start of a code of the other of the full constructor and the partial constructor which is not deleted.

10. The compiling method according to claim 9,
wherein, in said special function consolidating step, the code which consolidates the full destructor and the partial destructor among the plural destructors of the class that is not defined by virtual inheritance is generated by deleting a code of one of the full destructor and the partial destructor, and by placing a label indicating a starting address of the full destructor and a label indicating a starting address of the partial destructor, at a start of a code of the other of the full destructor and the partial destructor which is not deleted.

11. A compiling program recorded on a computer-readable recording medium, for converting, into an object program, an input program written in an object-oriented language and having at least one class, said compiling program causing a computer to execute:
a virtual inheritance analyzing step of analyzing whether or not each class in the input program is defined by virtual inheritance;
a special function consolidating step of generating a code which consolidates at least one of plural constructors and plural destructors of the class, in the case where a result of said virtual inheritance analyzing step shows that the class is not defined by virtual inheritance; and
a generating step of generating an object program including the code generated in the special function consolidating step.

12. The compiling program according to claim 11,
wherein, in said virtual inheritance analyzing step, whether or not the class is defined by virtual inheritance is analyzed based on a class definition described in the input program.

13. The compiling program according to claim 11,
wherein, in said virtual inheritance analyzing step, whether or not the class is defined by virtual inheritance is analyzed based on a language specification control statement which is a control statement described in the input program according to a language specification.

14. The compiling program according to claim 11,
wherein, in said virtual inheritance analyzing step, whether or not the class is defined by virtual inheritance is analyzed based on a language specification control instruction which is a control instruction described according to a language specification of a compiling system compiling the input program.

15. The compiling program according to claim 11,
wherein, in said special function consolidating step, a code which consolidates a full constructor and a partial constructor is generated, the full constructor being a constructor which is called when generating a full class object which is not a partial class object making up a class object and the partial constructor being a constructor which is called when generating a partial class object included in a class object, among plural constructors of the class that is not defined by virtual inheritance.

16. The compiling program according to claim 15,
wherein, in said special function consolidating step, a code which consolidates a full destructor and a partial destructor is generated, the full destructor being a destructor which is called when generating a full class object which is not a partial class object making up a class object and the partial destructor being a destructor which is called when generating a partial class object included in a class object, among plural destructors of the class that is not defined by virtual inheritance.

17. The compiling program according to claim 11,
wherein, in said special function consolidating step, the code which consolidates the full constructor and the partial constructor among the plural constructors of the class that is not defined by virtual inheritance is generated by replacing a call command of one of the full constructor and the partial constructor, with a call command of the other of the full constructor and the partial constructor, and by deleting a constructor code of the one of the full constructor and the partial constructor which is the constructor of the replaced call command.

18. The compiling program according to claim 17,
wherein, in said special function consolidating step, the code which consolidates the full destructor and the partial destructor among the plural constructors of the class that is not defined by virtual inheritance is generated by replacing a call command of one of the full destructor and the partial destructor, with a call command of the other of the full destructor and the partial destructor, and by deleting a destructor code of the one of the full destructor and the partial destructor which is the destructor of the replaced call command.

19. The compiling program according to claim 11,
wherein, in said special function consolidating step, the code is which consolidates the full constructor and the partial constructor among the plural constructors of the class that is not defined by virtual inheritance is generated by deleting a code of one of the full constructor and the partial constructor, and by placing a label indicating a starting address of the full constructor and a label indicating a starting address of the partial constructor, at a start of a code of the other of the full constructor and the partial constructor which is not deleted.

20. The compiling program according to claim 19,
wherein, in said special function consolidating step, the code which consolidates the full destructor and the partial destructor among the plural constructors of the class that is not defined by virtual inheritance is generated by deleting a code of one of the full destructor and the partial destructor, and by placing a label indicating a starting address of the full destructor and a label indicating a starting address of the partial destructor, at a start of a code of the other of the full destructor and the partial destructor which is not deleted.

21. A compiling apparatus which executes a compiling method for converting, into an object program, an input program written in an object-oriented language and having at least one class, said compiling method comprising:
a virtual inheritance analyzing unit configured to analyze whether or not each class in the input program is defined by virtual inheritance;
a special function consolidating unit configured to generate a code which consolidates at least one of plural constructors and plural destructors of the class, in the case where a result of the analysis by said virtual inheritance analyzing unit shows that the class is not defined by virtual inheritance; and
a generating unit configured to generate an object program including the code generated by said special function consolidating unit.
